(19) United States
(12) Patent Application Publication
(10) Pub. No.: US 2018/0260749 A1
(43) Pub. Date: Sep. 13, 2018

(54) SYSTEM AND METHOD FOR FILTERING PROJECT INFORMATION FROM DISPLAY

(71) Applicant: Walmart Apollo, LLC, Bentonville, AR (US)

(72) Inventors: Jill Staugaard, Bentonville, AR (US); Pamela D. Baugus, Rogers, AR (US); Humberto Chavez, Centerton, AR (US); Matthew Hill, Bentonville, AR (US)

(73) Assignee: Walmart Apollo, LLC, Bentonville, AR (US)

(21) Appl. No.: 15/918,702

(22) Filed: Mar. 12, 2018

Related U.S. Application Data
(60) Provisional application No. 62/574,489, filed on Oct. 19, 2017.
(60) Provisional application No. 62/470,035, filed on Mar. 10, 2017.
(60) Provisional application No. 62/469,971, filed on Mar. 10, 2017.
(60) Provisional application No. 62/470,040, filed on Mar. 10, 2017.
(60) Provisional application No. 62/469,931, filed on Mar. 10, 2017.
(60) Provisional application No. 62/469,975, filed on Mar. 10, 2017.
(60) Provisional application No. 62/469,998, filed on Mar. 10, 2017.
(60) Provisional application No. 62/470,012, filed on Mar. 10, 2017.

(51) Int. Cl. G06Q 10/06; G06F 17/30

(52) U.S. Cl. CPC G06Q 10/0637; G06F 17/30554; G06F 17/30424

(57) ABSTRACT

Systems, methods, and non-transitory computer-readable storage media for filtering a project management system such that only desired categories are displayed. This filtering can occur using a variety of selection systems, such as drop-down menus, text searching, and other graphical user interface selections. The displayed project management data can automatically adjust to the selections, and modify/scale the associated project information based on those selections.

### CROSS REFERENCE TO RELATED APPLICATIONS

This application claims the benefit under 35 U.S.C. § 119(e) to U.S. Provisional Application No. 62/470,035 filed Mar. 10, 2017, U.S. Provisional Application No. 62/469,971 filed Mar. 10, 2017, U.S. Provisional Application No. 62/470,040 filed Mar. 10, 2017, U.S. Provisional Application No. 62/469,931 filed Mar. 10, 2017, U.S. Provisional Application No. 62/469,975 filed Mar. 10, 2017, U.S. Provisional Application No. 62/469,998 filed Mar. 10, 2017, U.S. Provisional Application No. 62/470,012 filed Mar. 10, 2017, and U.S. Provisional Application No. 62/574,489 filed Oct. 19, 2017, the disclosures of which are hereby incorporated by reference.

### BACKGROUND

### 1. Technical Field

The present disclosure relates to filtering project information, and more specifically to retrieving, formatting, and displaying project information.

### 2. Introduction

Gantt charts and other project management tools allow users to plan projects, operations, and resources effectively. However, when there are multiple parties using these planning tools, it can be difficult to reconcile/normalize data across organizations. In addition, because of the disparate types of information and data being provided by each organization, users of such project management tools often have difficulty in obtaining answers to specific questions.

### SUMMARY

A method based on the concepts disclosed herein can, for example, include: identifying, in a database, project information associated with a plurality of projects which have not been approved, wherein the project information contains a plurality of fields comprising: a date range for each respective project; a geographic region for each respective project, the geographic region comprising one of a city, a state, a country, a plurality of countries, and a continent; an enabling body responsible for completing each respective project; and a budget approval decision for each respective project; receiving, at a processor, instructions to retrieve the project information and format it for display on a display device, to yield display formatted project information; transmitting, to the display device, the display formatted project information for display, the display formatted project information having a first size; receiving a query for a field in the plurality of fields; modifying the display formatted project information based on the query such that only projects in the plurality of projects associated with the field are displayed, to yield modified display formatted project information having a second size, the second size being smaller than the first size; and transmitting, to the display device, instructions to display the modified display formatted project information.

A system configured according to the concepts disclosed herein can include, for example: a database; a display device; a processor; and a computer-readable storage medium having instructions stored which, when executed by the processor, cause the processor to perform operations comprising: identifying, in the database, project information associated with a plurality of projects, wherein the project information contains a plurality of fields comprising: a date range for each respective project; a geographic region for each respective project, the geographic region comprising one of a city, a state, a country, a plurality of countries, and a continent; an enabling body responsible for completing each respective project; a market strategy for each respective project; a domain for each respective project; and a budget approval decision for each respective project; receiving instructions to retrieve the project information and format it for display on a display device, to yield display formatted project information; transmitting, to the display device, the display formatted project information for display; receiving a query for a field in the plurality of fields; modifying the display formatted project information based on the query such that only projects in the plurality of projects associated with the field are displayed, to yield modified display formatted project information; and transmitting, to the display device, instructions to display the modified display formatted project information.

A non-transitory computer-readable storage medium configured to practice the concepts disclosed herein can include instructions stored which, when executed by a computing device, cause the computing device to perform operations including: identifying, in a database, project information associated with a plurality of projects, wherein the project information contains a plurality of fields comprising: a date range for each respective project; a geographic region for each respective project, the geographic region comprising one of a city, a state, a country, a plurality of countries, and a continent; an enabling body responsible for completing each respective project; and a budget approval decision for each respective project; receiving instructions to retrieve the project information and format it for display on a display device, to yield display formatted project information; transmitting, to the display device, the display formatted project information for display; receiving a query for a field in the plurality of fields; modifying the display formatted project information based on the query such that only projects in the plurality of projects associated with the field are displayed, to yield modified display formatted project information; and transmitting, to the display device, instructions to display the modified display formatted project information.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an exemplary first view of a project management system;

FIG. 2 illustrates a first exemplary view of the project management system when subjected to a filter;

FIG. 3 illustrates a second exemplary view of the project management system when subjected to a second filter;

FIG. 4 illustrates an exemplary view of the project management system with a first priority;

FIG. 5 illustrates an exemplary view of the project management system with a modified priority;

FIG. 6 illustrates an exemplary view of the project management system when a pending project is no longer pending;

FIG. 7 illustrates an exemplary view of the project management system when a first project is selected for display;

FIG. 8 illustrates an exemplary view of the project management system when the display area is scaled for the first project and a second project;

FIG. 9 illustrates an exemplary view of the project management system when adjusted for additional projects;

FIG. 10 illustrates an example method embodiment; and

FIG. 11 illustrates an exemplary computer system which can be used to perform the concepts disclosed herein.

### DETAILED DESCRIPTION

Project management systems often employ tools, such as Gantt charts, to ensure that resources are properly allocated. These tools generally take the form of horizontal bar charts, with the bars extending over periods of time and illustrating when the projects will start and end. However, while management tools allow users to view the overall project plans, improvements can be made regarding the ability to view particular data, adjust the data, approve projects, reject projects, and/or filter aspects of the viewed projects.

Systems configured according to this disclosure can operate more efficiently and/or faster than previous project management systems. Specifically, by deploying machine learning of specific inputs, the system can improve how it filters projects and features of projects, such that presentation of data can occur faster or without needing direction from a user. In addition, the system can improve prioritization of projects based on historical data, geographic regions, project types, etc., such that projects are prioritized in an improved manner over previous project management systems. By practicing the concepts disclosed herein, systems can display project management information faster, more efficiently, and more accurately than previous project management systems.

A first aspect of this disclosure is the ability to filter the projects being viewed in the project management system based on specific selections made by a user. For example, the project management system can have menus available to view all projects available, projects limited to specific geographic markets, world regions, subject matter domains, enabling organizations, and/or using keyword terms. These menus can, for example, be drop-down menus where selection of any specific category of project data can be selected. Selection via a drop-down menu can, for example, exclude any data not associated with the selected category from being displayed. Alternatively, menus can be “check-list” menus, where selection of a specific category initiates presentation of that particular type of data. In check-list menus, more than one specific category of data can be selected.

In addition, the project management system can display the organizations tasked with performing the projects with an accompanying legend identifying those organizations, strategies, or other identifying characteristics. In some configurations, users can enable check-list menu functionality by clicking (via the graphical user interface) on those specific organizations, and systems configured according to this disclosure can receive selections of those organizations by clicking on specific data categories within that legend. For example, the legend may have a symbol for “budget not approved.” In such configurations, users could then toggle viewing projects for which the budget has not been approved by clicking on the budget not approved symbol.

A second aspect of this disclosure is the ability to adjust and prioritize pending projects and plans. When organizations need to budget and allocate resources in a planned manner, there can often be projects pending approval. Approval can involve many steps, such as scheduling the project, approving the budgets for the project, obtaining funding for the project, allocation of human resources to the project, identifying dependencies which will exist for the project, which organization will be tasked with performing the project, and which market the project is focused on. Because the process to obtain approval can be time consuming, the project management system disclosed herein can allow for prioritization of pending plans. These prioritizations can then be adjusted as projects are added, as priorities change, as projects are approved or removed, etc.

For example, several pending projects may be prioritized as the top three pending projects, in a 1-2-3 prioritization, with several other projects not prioritized at all. If one of the un-prioritized projects received a priority of “4”, that project would be placed fourth in the priority queue. If that same project were to receive a priority of “2”, that project would be placed second in the priority queue, and the previous “2” and “3” projects would be automatically pushed to the third and fourth positions in the queue. Similarly, if a project is approved (or removed) from the pending projects queue, the remaining projects will have their priorities adjusted accordingly.

Another aspect of this disclosure is the scaling of the display area of the project management system. As the project information is displayed on a display device, specific portions of the display can be allocated to the menus, the project legends, the pending plans, and/or a timeline display of the projects. These portions of the display can be adjusted according to the amount of data being presented, and the display area associated with those portions can be scaled accordingly. For example, if projects associated with additional organizations are being displayed, the portion of the display area which act as a legend for those organizations can expand or contract as projects associated with the organizations are added and/or removed. The calculations associated with that expansion and/or contraction of specific portions can occur automatically. This automatic resizing can occur so that as the user selects/deselects various aspects of data, the space allocated to the various portions associated with those projects automatically adjusts on the screen/display device.

Another example of such resizing can occur when the timeline display of projects is adjusted as projects are added or removed from the display area. For example, as a project is selected for display within the display area, the project management system can identify the beginning and end of that project. If the information associated with that project needs to be modified, scaled, or otherwise manipulated to fit within the allocated time of the display area, the project management system can perform those modifications Likewise, if the project information requires that the display area itself be scaled, modified, or otherwise manipulated, the project management system can perform those changes. In this manner, the display space allocated for information associated with the different portions of the projects can be modified, in real-time or near real-time, based on the addition or removal of projects from display.

Yet another aspect of this disclosure is the ability to search, sort, and modify the projects being displayed according to the geographic regions. For example, if a project were being associated with North America at a high level, a sub-level of that project could be the implementations of the project within Mexico, the United States, and Canada. A user might then select to focus in on the United States, at which point the project management system can provide implementation information for the next sub-level of that project for the United States, which could be the implementation of that project for each of the fifty states, implementation for specific regions of the United States, etc. This ability to “zoom,” into and out of geographic regions can also allow for removal of information associated with projects not associated with the selected geographic region. In the example given above, if the user were to select Canada, and not select the United States and/or Mexico, some configurations can allow project information associated with the United States and Mexico to be removed. Likewise, moving back “up” to a wider geographic area can result in regions being added to the displayed information. For example, if the United States were being displayed (without Canada or Mexico), and the user were to select North America, the data of Canada and Mexico could be added to the displayed information.

The ability to “zoom,” or otherwise move up and down geographic regions, can be based on fixed relationships which a user enters when the data is entered. For example, as the project information is entered, a user can enter unique geographic entities for the respective project components. Alternatively, the project management system can access a geographic database to identify the relationships between project components, thereby establishing geographic dependencies. For example, a user may enter that a certain type of project needs to occur in two distinct locations—Los Angeles and San Francisco. The project management system may use that information, in conjunction with a geographic database, to create a higher level project encompassing both the Los Angeles and San Francisco components, and title the higher level project “California.”

Another aspect of this disclosure is the ability to group projects and “zoom” within the projects based on market strategy. Market strategy can be work in parallel with geographic region, and can be subdivided and spread over different areas. Some exemplary categories of market strategy can be advertising, in-store sales, online sales, entry-level products (such as printers, where greater profits are made on the ink cartridges than the printer itself, or video game consoles, where higher profits are made on sales of individual video than the console itself), and the like. The market strategy can also reflect a geographic region where the marketing is being applied versus the geographic region where the project will be implemented (aka “Region”). As projects are entered into the project management system, the system can automatically group the projects according to the various marketing strategies of the system. This grouping can be based on types and associations of marketing strategies specified for a particular configuration, or can be based on types and associations of marketing strategies as found in a database.

Based on the different groupings of marketing strategies, the project management system can allow for “zooming” in and out of projects based on the provided categories. For example, a selection of “advertising” can produce sub-categories of “radio,” “billboard,” television,” and “newspaper.”

In addition, market strategy can be linked to other databases regarding past projects to evaluate the effectiveness at particular marketing strategies for those past projects, then relay that information to users evaluating market strategy for new projects. For example, using a combination of past projects, the marketing strategy of those past projects, and profits from those past projects, the project management system can determine which types of marketing should be applied at distinct stages of a project, to whom that marketing should be addressed, and when a shift to a distinct type of marketing strategy should be employed to maximize the potential return. When a user creates a new project, the program management system can identify the geographic location of the project, the total time for the planned project, the proposed budget, and other factors, then use the conclusions of the previous analysis on past data to suggest a market strategy for the new project. In some configurations, users can adjust the budget, the total time for the project, etc., and see, in real-time or near real-time, alternative marketing strategies suggested by the program management system.

Another aspect of this disclosure is the ability to group projects and “zoom” within the projects based on the domain of the project. Domain can refer to the general effect of the project, such as customer satisfaction, worker morale, infrastructure maintenance, etc. Domain can also refer to a general business area, responsible organization, authority, jurisdiction, or other aspects of a project being associated with a specific category.

Yet another aspect of this disclosure is the search capability across data received from multiple organizations. Because the data can be received and organized in a normalized manner, the data can be searched using keyword searching. The keyword searching can be augmented by a database containing a thesaurus or other alternative terms which may be identified by a user, or a user group. Non-limiting examples of the data which can be included within the project management system can include the elements listed in Table 1, accompanied by definitions of the data and how the data is input into the project management system.

TABLE 1

| Fields | Definition | Input Method |
|---|---|---|
| Project Name | Common title or name given to a System | Freeform field |
| | or business process to be implemented at | |
| | market level referenced by stakeholders | |
| Project Description | Explains the Initiative purpose, | Freeform field |
| | objectives and/or goals | |
| Market | May be a country or a roll up of multiple | Automatically mapped |
| | countries | depending on country |
| | | selection or Dropdown |
| Country | Location in which the project is | Dropdown |
| | occurring | |
| Region | Depending on configuration, can be | Automatically mapped |
| | multiple countries or portions of a | depending on country |
| | country | selection or Dropdown |
| Systems | Application to be delivered as part of the | Dropdown |
| | project | |
| System Acronym | Further explanation for system or system | Freeform field |
| Description | acronym spelled out | |
| System Type | Category of the system - can be global, | Dropdown |
| | interim, local, or common | |
| System Implementation | Category of the status of the system - can | Dropdown |
| state | be planned required, ongoing, completed, | |
| | planned | |
| Capability | Most precise level of the domain | Dropdown |
| | structure that identifies business | |
| | functionality, competency or skillset to | |
| | be delivered by the Initiative | |
| International Priority | Order of completion of the task | Freeform field |
| | according to the business and/or market | |
| Domain | Logical grouping of categories that align | Dropdown |
| | to the business. | |
| Domain Group | Comprised of multiple domains based on | Dropdown |
| | business alignment | |
| Domain Layer | Comprised of multiple domain groups | Dropdown |
| | based on business alignment. | |
| Submitted By | Entity that has requested for the initiative | Dropdown |
| | to take place | |
| Enabled By | Identifies the organization responsible for | Dropdown |
| | completing the work | |
| Funded By | Identifies the organization responsible for | Dropdown |
| | funding the work | |
| Market Strategy | A plan of action or major goal identified | Freeform field |
| | by the market as a key to their overall | |
| | success in meeting business objectives. | |
| Forum or Business | Approval or non-approval received from | Boolean - Yes/No |
| Approved | the business to move ahead with the | |
| | work | |
| Business readiness | Indication that business readiness | Boolean - Yes/No |
| needed | activities are needed alongside technical | |
| | work in order to complete the initiative | |
| Business readiness | Actions to be completed under the | Dropdown |
| activity | direction of the business | |
| Business readiness | Actions to be completed under the | Dropdown |
| activity 2 | direction of the business | |
| Business readiness | Actions to be completed under the | Dropdown |
| activity 3 | direction of the business | |
| Business readiness | Actions to be completed under the | Dropdown |
| activity 4 | direction of the business | |
| Business readiness | Actions to be completed under the | Dropdown |
| activity 5 | direction of the business | |
| Business readiness | Actions to be completed under the | Dropdown |
| activity 6 | direction of the business | |
| Has budget approved | Indication of funding availability for the | Boolean - Yes/No |
| | work | |
| Project planned start | The date at which project work is | Calendar flyout menu |
| date | expected to begin as designated by the | or type in |
| | enabled by | |
| Project planned end | The date at which as Initiative work is | Calendar flyout menu |
| date | expected to end as designated by the | or type in |
| | enabled by | |
| Technology Status | Progression of a technology in obtaining | |
| | desired results | |
| Milestone1 | Action or event making a significant | Freeform field |
| | change or stage in development | |
| Date1 | Date at which the milestone should be | Calendar flyout menu |
| | complete | or type in |
| Milestone2 | Action or event making a significant | Freeform field |
| | change or stage in development | |
| Date2 | Date at which the milestone should be | Calendar flyout menu |
| | complete | or type in |
| Milestone3 | Action or event making a significant | Freeform field |
| | change or stage in development | |
| Date3 | Date at which the milestone should be | Calendar flyout menu |
| | complete | or type in |
| Milestone4 | Action or event making a significant | Freeform field |
| | change or stage in development | |
| Date4 | Date at which the milestone should be | Calendar flyout menu |
| | complete | or type in |
| Milestone5 | Action or event making a significant | Freeform field |
| | change or stage in development | |
| Date5 | Date at which the milestone should be | Calendar flyout menu |
| | complete | or type in |
| Milestone6 | Action or event making a significant | Freeform field |
| | change or stage in development | |
| Date6 | Date at which the milestone should be | Calendar flyout menu |
| | complete | or type in |
| Dependency | Activities that are required to happen in | Freeform field |
| | order for something else to take place | |
| Plan required label | Indicator of whether or not the project or | Dropdown |
| | work has a set date - could be a | Boolean - Yes/No |
| | placeholder | |
| Domain 1 | Secondary domain identified that has | Dropdown |
| | ownership in some of the work | |
| Domain 2 | Secondary domain identified that has | Dropdown |
| | ownership in some of the work | |
| Domain 3 | Secondary domain identified that has | Dropdown |
| | ownership in some of the work | |
| Corporate Budget | Dollar amount that the corporate | Freeform field |
| (Dollars) | business/partners will be funding for the | |
| | work | |
| Local Budget (Dollars) | Dollar amount that the local/in country | |
| | business will be funding for the work | |
| Replaces End Of Life | Indication if the project will be replacing | Boolean - Yes/No |
| System | another system that was identified as | |
| | becoming obsolete | |
| End Of Life Date | Date at which the obsolete system will be | Calendar flyout menu |
| | completely unusable or unavailable | or type in |
| Additional Supporting | | |
| Information | | |
| Additional comments | Field for further explanations about the | Freeform field |
| | project | |
| Deletion Status | | |
| User Name | Autopopulated by the system | |
| Date Time Stamp | Autopopulated by the system | |

Data entry for the projects can occur via a variety of mechanisms. In one scenario, a user enters project data by directly inputting data into a database. This data can be, for example, comma separated or in an SQL format, and can be stored in a shared folder or otherwise shareable, accessible database. In other scenarios, the data can be input using a project entry tool, program, application, or module, where the data is received by the program entry tool, modified according to reflect the needs of the database, and entered into the database. Such entry can occur one data entry at a time, or via bulk upload. In some configurations, this tool can also modify the data being entered according to the type of projects the program management system is configured to present and review. If, for example, the program management system is configured to present and review a subject matter domain which is easily quantifiable, the data entry tool can modify the data being entered to reflect individual points of data. Alternatively, if the subject matter domain of the project is not easily quantifiable, the data entry tool can modify the data to reflect less quantifiable data using, for example, quality terms such as “bad,” “okay,” “good,” rather than numerical ranges. The program management system can also be configured to provide a data entry module for these quality terms to the user.

As projects are entered, they are processed through a rules engine (or other mechanisms) to determine if any subsequent data should be extracted, added, or modified, based on the project entry. For example, if a project is for a given region, the system, via the rules engine, may ask for any sub-regions affected (or not affected) by the project. In addition, the rules engine can create marks, or Boolean notations, indicating that visual icons should be displayed next to the project information based on project data. As data is retrieved for project visualization, the project information for each project is further transformed according to the rules engine, such that each project is displayed according to user preferences.

Various embodiments of the disclosure are described in detail below, accompanied by illustrations. While specific implementations are described and illustrated, it should be understood that this is done for exemplary purposes only. Other components and configurations may be used without parting from the spirit and scope of the disclosure.

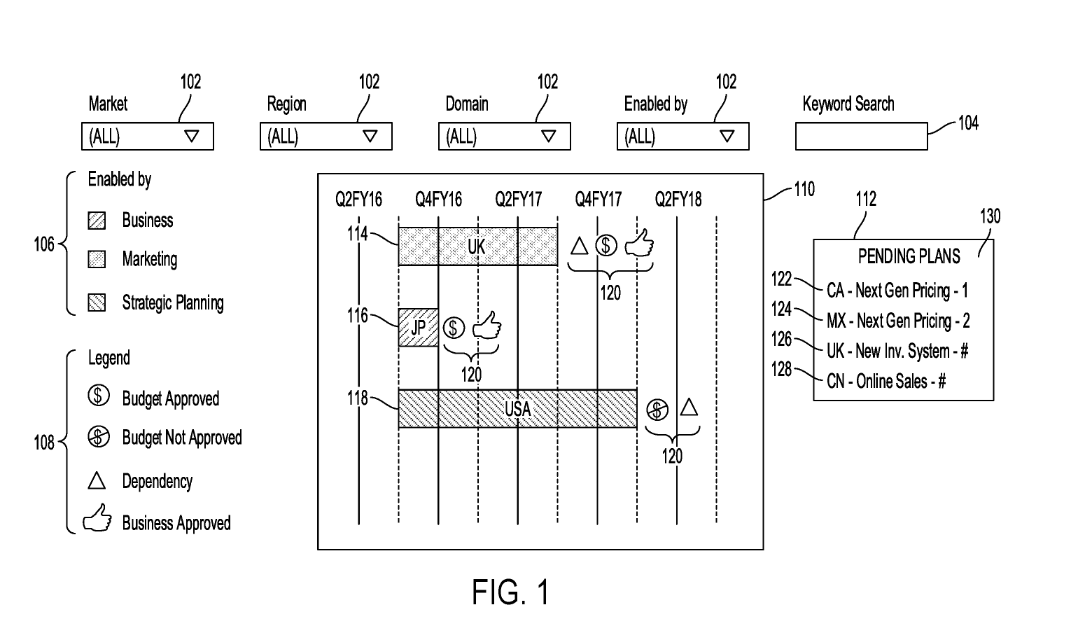

FIG. 1 illustrates an exemplary first view 100 of a project management system. In this example, there are four general sections. The first section is the filtering, or selection, section 102, 104. In the filtering section users of the project management system can select to view all the options available for any particular field, or can select, via a drop down menu 102. Exemplary drop down menus 102 can include the Market in which the project will occur (such as specific demographics, businesses, etc.), Region (such as a geographic location), the Domain/Subject Area of the project, and an Enabling Organization responsible for completing the project. In addition, the users can enter text into a keyword search and can filter out any project information not having that keyword. Alternatively, the keyword search can be used to identify and display any data associated with the keyword.

A second section being displayed is an explanatory section encompassing a legend 108 for items being displayed by the project management system and a list of enabling organizations 106. In some configurations, users can make selections of organizations via the list of enabling organizations 106, where when the user selects an organization in the list 106 projects associated with that organization are presented or removed. Likewise, in some configurations uses can choose to view specific types of projects based on the legend 108, where when a user selects a symbol or description from the legend 108, projects associated with the selected symbol are presented or removed.

A third section of the displayed project management system is the timeline display area 110. Within this area projects 114, 116, 118 are displayed across time periods. The projects 114, 116, 118 in the illustrated example are horizontal bars extending across multiple quarters of the years being displayed. The amount of time represented within the display area 110 can vary according to the projects 114, 116, 118 being presented, or can be predetermined.

Each project 114, 116, 118 displayed within the timeline display area 110 can be marked with information identifying the geographic region of the project, the enabling organization, the domain of the project, the market of the project, etc. Such distinguishing factors can be made using color, shading, font, etc. In addition, each project 114, 116, 118 can have symbols 120 placed next to each respective project, with the symbols 120 corresponding to the symbols of the legend 108. The symbols can represent various features of the project, such as if the budget for the project has been approved or not approved, any dependencies which may exist, and if the project has been approved to begin being incorporated into business operations.

A fourth section of the displayed project management system is a section devoted to pending plans 112. Whereas the timeline display area 110 displays projects which have been approved, in this section 112 plans which have not yet been approved are listed. The display of pending plans 112 can be organized by priority, such that those items with top priority are listed at the top of the pending plans 112 list, and those items with lower priority (or an unassigned priority “#”) are displayed at the bottom of the list of pending plans.

Another section of the project management system which can be displayed (and which is not illustrated) is a section providing additional notes or disclosure regarding a selected project. Yet another section (not illustrated) can provide computer-generated recommendations for projects based on information gathered from a database of previous project management. For example, the database can record variables associated with a project (such as those found in Table 1), and correlate that information with results during the project and after the project. Then, when future projects are being displayed or entered, the project management system can propose dates, seasons, regions, and other variables as the projects are being entered and then as the projects are displayed. An example of this analysis of past data being used to provide project recommendations is that the system identifies that projects which are initiated in a first region, then repeated in a second region result in better results than when projects are first initiated in the second region or initiated in both regions simultaneously. Accordingly, the system suggests to the user, as a new project is being introduced to the first and second regions, that the project be first implemented in the first region. This analysis of data can occur as a new project is being entered, but can also occur as results are received by the project management system.

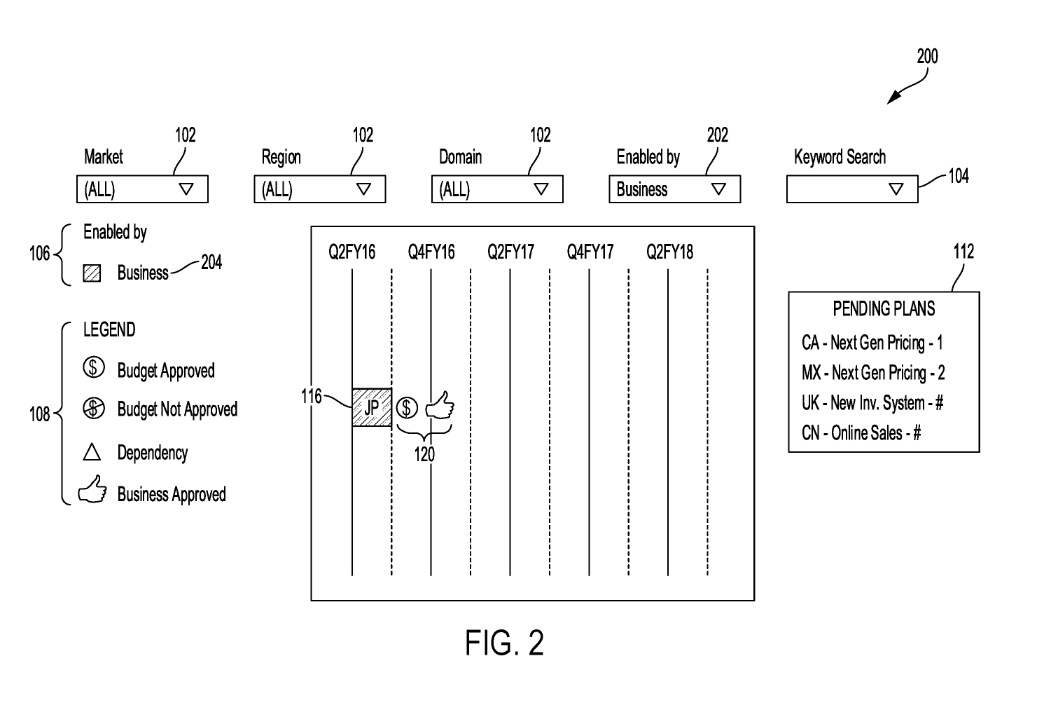

Exemplary Configuration 1: Filtering project information from display. FIG. 2 illustrates a first exemplary view 200 of the project management system when subjected to a filter. In this case, the filter is the selection of “business” as the enabling organization using a dropdown menu 202 (in some configurations, selection of business can occur by clicking on “business” in the list of enabling organizations 106). As a result of the selection, only “business” is presented as active in the list of enabling organizations 106. The other enabling organizations can be removed, faded, or otherwise marked as inactive when the selection has occurred. The selection of “business” as the enabling organization also removes those projects 114, 118 from the timeline display area, resulting in only a single project 116 being displayed with its accompanying symbols 120. At this point, the timeline display area can, in certain configurations, be rescaled or modified.

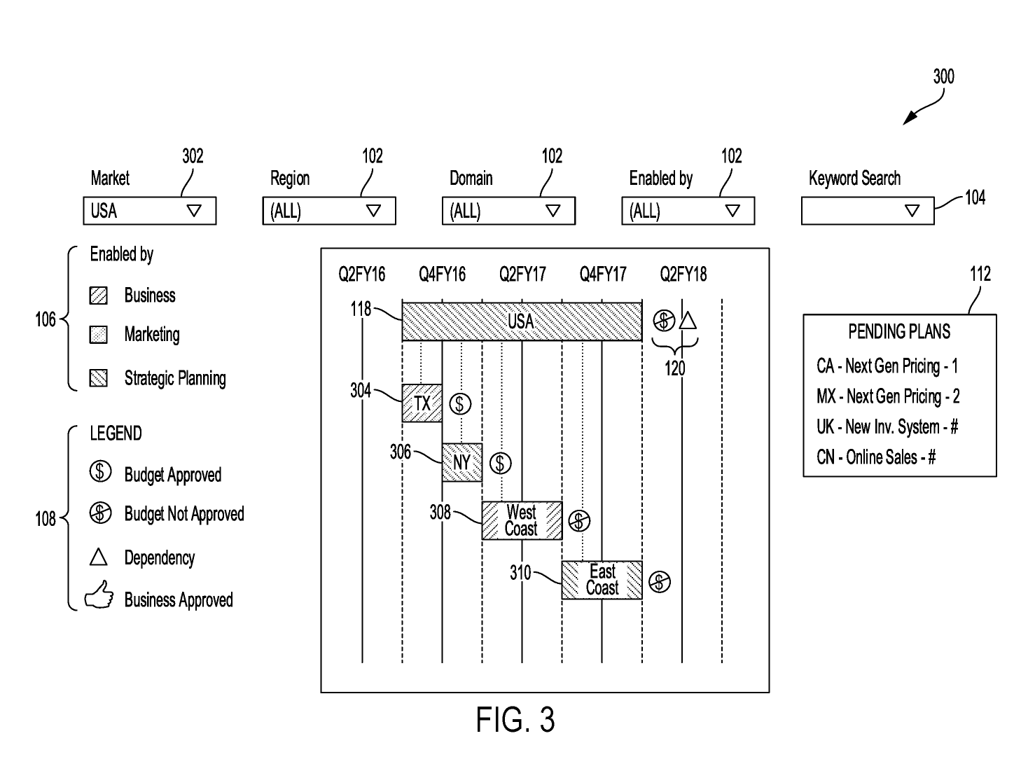

FIG. 3 illustrates a second exemplary view 300 of the project management system when subjected to a second filter. In this example, the filter is the selection of “USA” 302 as where the marketing will occur. This selection 302 does not necessarily identify the regions where the project 118 will be implemented. In this example 300, the selection causes the project management system to display the dependencies 304, 306, 308, 310 of project 118. Each of the dependencies 304, 306, 308, 310 can have their own associated symbols. In addition, the dependencies 304, 306, 308, 310 can be staggered (as illustrated), or can overlap as required. In addition, the dependencies 304, 306, 308, 310 illustrated all correspond to the same enabling organization as the parent project 118. However, in other cases the sub-projects 304, 306, 308, 310 which depend from the parent project 118 can be associated with distinct organizations, markets, regions, etc., than the parent project 118. Filtering of these sub-projects can occur using the same tools 102, 104, 106, 108 used for filtering higher level projects.

A system can be configured to practice these principles via a method. An exemplary method can, for example, be performed by a server or other computing device connected to databases and display devices. The server can identify, in a database, project information associated with a first project and a second project, wherein the project information includes a date range for each respective project, a geographic region for each respective project, the geographic region comprising one of a city, a state, a country, a plurality of countries, and a continent, an enabling body responsible for completing each respective project, and a budget approval decision for each respective project.

The server receives instructions to retrieve the project information and format it for display on a display device, to yield display formatted project information. The server transmits, to the display device, the display formatted project information for display. The server then receives a request to remove projects associated with a specific category of data from display and identifies the first project as being associated with the specific category of data. The server then removes the project information associated with the first project from the display device.

The method can be further implemented by receiving, at the server, a request to add project associated with a particular category of data to the display device, identifying, in the database, a third project as being associated with the particular category of data, and displaying, on the display device, additional project information associated with the third project. The particular category of data can be, for example, selected via a drop-down menu.

Another way in which the method may be further implemented is by identifying, in the database, a third project as being associated with the specific category of data, and displaying, on the display device, additional project information associated with the third project.

The specific category of data can be, for example a geographic region, and wherein the identifying of the first project as being associated with the specific category of data further includes searching the database for projects associated with the geographic region and searching the database for organizations associated with the geographic region. The organizations can be, for example, business units to whom the projects are assigned.

The project management system can utilize a text search window to receive text which the user wishes to identify in the project information being presented. Other mechanisms for filtering, selecting, or otherwise modifying the view of the display can include drop-down menus, touch screen interfaces on portions of the displayed project information, etc.

Example Configuration 2: Refining project management information based on geographic region. In some configurations, the project management system can be filtered for a specific geographic region. In the example of FIG. 3, the user could select, via a drop down menu, the region as U.S.A. The projects not associated with the U.S.A. region are removed from the timeline display area 110, resulting in only the U.S.A. project being displayed.

However, in this example, the project management system also detects that the U.S.A. project is dependent on sub-projects. The project management system has populated the timeline display area 110 with these sub-projects 304, 306, 308, 310. In this example, the sub-projects 304, 306, 308, 310 each require a portion of the time of the overall parent project 118, and do not overlap. In other examples, the sub-projects 304, 206, 208, 210 may overall. In addition, the illustrated sub-projects all share the same enabling organization (illustrated by the graphical similarity). However, in other instances the sub-projects 304, 306, 308, 310 may have multiple components, and the parent project 118 may not be specific to any particular enabling organization.

A system can be configured to practice these principles via a method. A server configured as described herein can, for example, identify, in a database, project information associated with a first project and a second project, wherein the project information comprises: a date range for each respective project; a geographic region for each respective project, the geographic region comprising one of a city, a state, a country, a plurality of countries, and a continent; an enabling body responsible for completing each respective project; and a budget approval decision for each respective project. The server then receives instructions to retrieve the project information and format it for display on a display device, to yield display formatted project information. The server transmits to the display device, the display formatted project information for display, and receives a request to display projects associated with a specific geographic region. The server identifies the first project as not being associated with the specific geographic region, and removes the project information associated with the first project from display on the display device.

Examples of geographic regions can be continents, countries, states, provinces, counties, cities, etc. These geographic regions can be differentiated from one another within displayed project information using at least one of a different color, a different shading, a different font, and a different shape. In some configurations, the request to display projects associated with the specific geographic region can further comprise a request to display sub-regions of projects associated with the specific geographic region. For example, if a user selects a country, the program management system can identify states, counties, or cities as sub-regions of the specific country. For each of the identified sub-regions, the program management system can automatically generate sub-projects.

In some instances, the project management system can generate these sub-projects associated with the sub-regions based on historical data. The project management system can record how a user, or users, have previously interacted with projects, and more specifically which sub-projects the user has generated after they've created a “parent” project. The project management system can then employ machine learning, artificial intelligence, or deep learning algorithms on the recorded data to identify patterns within the past behavior. These algorithms can also identify correlations between regions, project types, project information (geographic region as well as market, domain, and/or enabling organization), and automatically create sub-projects and populate those sub-projects with related project information.

As an example, a user has established a pattern of creating projects assigned to the geographic region of the U.S.A. Each time the user does this, the user also creates two sub-projects on which the parent/U.S.A. project depends—one for the Eastern U.S. and one for the Western U.S. The project management system, using a machine learning algorithm, identifies this pattern in stored data, and when the user creates a new project and designates the geographic region as U.S.A., the project management system can, based on that machine learning, then automatically generate those sub-projects for the Eastern U.S. and Western U.S., and populate project information for those sub-projects with information gleaned from the machine learning analysis.

In such configurations, the method can be augmented to include: receiving new project information associated with a new project; identifying the geographic region identified in the new project information, to yield new project geographic area; extracting, from a database of geographic regions, additional geographic regions associated with the new project geographic area; and generating new sub-projects associated with each of the additional geographic regions, wherein the new project has dependencies from the new sub-projects. In addition, the method can include identifying, via machine learning, patterns within a database of projects, wherein changes to projects associated the specific geographic region are replicated in additional projects associated with a second geographic region; and modifying, based on the machine learning, the additional projects based on the patterns identified.

Exemplary Configuration 3: refining project management information based on market strategy. In this example (using FIG. 2 as a base), the project management system is filtered for a specific market strategy. In this example, the user has selected, via a drop down menu 102, projects associated with the market strategy “Online”. The projects associated with the selected market strategy remain in the timeline display area 110, while those projects not associated with the selected marketing strategy are removed from the timeline display area 110.

A system can be configured to practice these principles via a method. A server configured as described herein can identify, in a database, project information associated with a first project and a second project, wherein the project information comprises: a date range for each respective project, a geographic region for each respective project, the geographic region comprising one of a city, a state, a country, a plurality of countries, and a continent, an enabling body responsible for completing each respective project, and a budget approval decision for each respective project. The server can receive instructions to retrieve the project information and format it for display on a display device, to yield display formatted project information. The server transmits, to the display device, the display formatted project information for display and receives a request to display projects associated with a specific market strategy. At this point the server can identify the first project as not being associated with the specific market strategy and remove the project information associated with the first project from the display device.

The marketing strategies entered by users into the system can be changed, modified, or otherwise altered by the project management system using machine learning, or artificial intelligence algorithms, which recognize patterns of behavior and seek to replicate those patterns when new instances (projects) are presented. In one example, each marketing strategy in the project information for each project is one of a plurality of marketing strategies, and wherein the plurality of strategies is automatically adjusted, via the processor, based on trends identified on the Internet. That is, in this example, the algorithm can identify trends within marketing strategy relationships based on Internet based trends. These trends can be based on the number of times topics or subject areas are co-located on a web-page, or within a web domain. In other instances, the artificial intelligence algorithm can identify how specific users have interacted with projects and, based on those interactions, determine that the strategies are related to one another. In some configurations, adjustments made by the project management system (using machine learning, artificial intelligence, or other algorithms) can occur at fixed intervals. For example, every month (or week, day, etc.) the project management system can modify marketing strategies based on relationships between marketing strategy types using data collected from Internet resources. In still other configurations, the determination to modify relationships is based on a threshold number of relationships being identified. For example, if two distinct marketing strategies are identified together in a threshold number of websites or databases, the project management system can be triggered to update marketing strategies and/or marketing strategy relationships for projects stored within a project database.

In addition, when new projects are added to the project management system, the system can rely on the identified relationships to suggest alternatives to the marketing strategy, or make suggestions for sub-projects to the new project, where the sub-projects are associated with distinct marketing strategies than that of the parent project. For example, the system may identify that each time a new project is made, the user generates sub-projects associated for print advertising, online advertising, and television advertising. Each of these sub-projects would be tied to the parent project, and the parent project would depend on the sub-projects, however each sub-project would be associated with a distinct marketing strategy. In addition, while the parent project may have an overall marketing strategy, the sub-projects may be identified with distinct marketing strategies from the parent project. For example, a project may be associated with online marketing, but a sub-project may be concerned with print advertising.

In some configurations, the specific marketing strategy being selected may be requested via a drop-down menu using a graphical user interface, text query/search box, voice query, or other data entry mechanism. In addition, when the projects are being input into the system, the market strategy can be automatically populated within the project information for each project based on historical data associated with a user initiating a project. For example, the market strategy can be automatically set based on a database of past market strategies, based on user preferences, user history, a history of interactions performed by other users, etc. If the user then needs to change or otherwise update the market strategy, they can then make the modifications necessary.

In some configurations, the method can be augmented by performing a market strategy similarity analysis of projects stored within the database, wherein the market strategy similarity analysis uses online resources to determine a degree of relatedness between distinct market strategies, and generating, based on the market strategy similarity analysis, relatedness scores for each project stored within the database to each remaining project stored in the database, where the identifying of the first project as not being associated with the specific market strategy is based, at least in part, on the relatedness scores.

In other configurations, removing the project information associated with the first project from the display device can include modifying, via the processor, a graphical output being sent to the display device such that the graphical output no longer contains the project information associated with the first project. In such cases the method can be expanded to include identifying a third project as associated with the specific market strategy and not currently displayed; retrieving third project information associated with the third project; formatting graphical information associated with displaying the third project information, to yield formatted third project information; modifying the graphical output to include the formatted third project information for display, to yield modified graphical output; and transmitting the modified graphical output to the display device.

In some configurations, each market strategy in the project information for each project is one of a plurality of previously identified market strategies, and the plurality of previously identified market strategies are automatically adjusted based on trends identified on the Internet. In such configurations, the automatic adjustments can occur at fixed intervals (such as once a day, once an hour, or once a week), or can occur dynamically based on specific conditions being met. One example of conditions being met, which trigger updating the market strategies, can be a certain number of websites introducing new vocabulary or new contact information. Another trigger can be specific, previously identified websites having a threshold level of similarity. Yet another trigger can be a modification by a user to a model, or database, of relationship terms, such that the modification triggers the marketing strategies of existing projects within a project information database to be updated.

Exemplary Configuration 4: refining project management information based on domain. In another example, the project management information can be filtered for a specific domain. In this example (again based on FIG. 2), the user can select, via a drop down menu 102, projects associated with the domain “Corporate”. The projects associated with the selected domain remain in the timeline display area 110, while those projects not associated with the selected domain are removed from the timeline display area 110.

A system can be configured to practice these principles via a method. A server configured as described herein can identify, in a database, project information associated with a first project and a second project, wherein the project information comprises: a date range for each respective project; a geographic region for each respective project, the geographic region comprising one of a city, a state, a country, a plurality of countries, and a continent; an enabling body responsible for completing each respective project; and a budget approval decision for each respective project. The server then receives instructions to retrieve the project information and format it for display on a display device, to yield display formatted project information, and transmits, to the display device, the display formatted project information for display. The server receives a request to display projects associated with a specific domain and identifies the first project as not being associated with the specific domain before removing the project information associated with the first project from the display device. Examples of the domains which can be associated with the projects include customer care, employee education, supply chain management, corporate improvement, inventory management, and customer relations.

The selection of the specific domain can occur via a drop-down menu, a keyword search, or other mechanisms. In addition, the removing of the project information associated with the first project from the display device can include modifying, via the processor, a graphical output being sent to the display device such that the graphical output no longer contains the project information associated with the first project. The method can then be further augmented by identifying a third project as associated with the specific domain and not currently displayed; retrieving third project information associated with the third project; formatting graphical information associated with displaying the third project information, to yield formatted third project information; modifying the graphical output to include the formatted third project information for display, to yield modified graphical output; and transmitting the modified graphical output to the display device.

In some configurations, the method can further include performing a domain similarity analysis of projects stored within the database, wherein the domain similarity analysis uses online resources to determine a degree of relatedness between distinct domains; and generating, based on the domain similarity analysis, relatedness scores for each project stored within the database to each remaining project stored in the database, wherein the identifying of the first project as not being associated with the specific domain is based, at least in part, on the relatedness scores. Online resources can, for example, include websites, public databases, private databases, and/or databases behind a paywall.

The domains entered by users into the system can be changed, modified, or otherwise altered by the project management system using machine learning, or artificial intelligence algorithms, which recognize patterns of behavior and seek to replicate those patterns when new instances (projects) are presented. In one example, each domain in the project information for each project is one of a plurality of domains, and wherein the plurality of domains is automatically adjusted, via the processor, based on trends identified on the Internet. That is, in this example, the algorithm can identify trends within domain relationships based on Internet based trends. These trends can be based on the number of times topics or subject areas are co-located on a web-page, or within a web domain. In other instances, the artificial intelligence algorithm can identify how specific users have interacted with projects and, based on those interactions, determine that the domains are related to one another. In some configurations, adjustments made by the project management system (using machine learning, artificial intelligence, or other algorithms) can occur at fixed intervals. For example, every month (or week, day, etc.) the project management system can modify domains based on relationships between domain types using data collected from Internet resources. In other configurations, the determination to modify relationships is based on a threshold number of relationships being identified. For example, if two distinct domains are identified together in a threshold number of websites or databases, the project management system can be triggered to update domains and/or domain relationships for projects stored within a project database.

In addition, when new projects are added to the project management system, the system can rely on the identified relationships to suggest alternatives to the domain, or make suggestions for sub-projects to the new project, where the sub-projects are associated with distinct domains. For example, the system may identify that each time a new project is made, the user generates sub-projects associated for marketing, human resources, and corporate. Each of these sub-projects would be tied to the parent project, and the parent project would depend on the sub-projects, however each sub-project would be associated with a distinct domain. In addition, while the parent project may have an overall domain, the sub-projects may be identified with distinct domains from the parent project. For example, a project may be associated with marketing, but a sub-project may be concerned with corporate aspects.

Exemplary Configuration 5: modifying project management information based on search queries. In this example (which can be based on FIG. 2), the user has entered, via the keyword search window 104, projects associated with “Supply Chain”. Projects associated with the query, or having associated keywords, remain in the timeline display area 110, while those projects not associated with the query are removed from the timeline display area 110.

In some configurations, the project management system, upon receiving a query, can (in addition to filtering the displayed data) also modify the project information. In one scenario, the project information associated with projects is modified to better accommodate display on a display device and/or graphical user interface. In such cases, modification of the project information can include modifying information being displayed (i.e., manipulate the dates/values to better align with other information), or can modify data representing that information. As an example, if a project has information identifying the duration as “January 15, 3:30 pm-February 10, 10:30 am”, modification of the actual project information may change the data to something less specific, such as “January 15-February 10,” removing the times of day. Another example of modifying the actual project information in this example could result in the time being extended to include seconds, such as “January 15, 3:30 pm, 15 seconds-February 10, 10:30 am, 20 seconds.” Such precision may be desired, for example, where projects require transmitting/receiving electronically transferred funds, transmit completion notices, feed into parent projects, etc.

In some instances, the project information can be copied or otherwise replicated such that the information being displayed or utilized is not the original project information. For example, project information can be copied or otherwise used to generate the information displayed by the display device. As items are selected, or filtered, using a Graphical User Interface or other input/output mechanism, modifications to the copy of the project information data can occur. For example, while the actual project information may state “January 15, 3:30 pm” as the project ending date, the project information displayed can be modified to only show “January,” be modified to reflect “first quarter,” or a similar modification.

These modifications can be made to provide an overall perspective on projects by providing a broader scope of each project (and removing details), can be made to provide additional details, or can be made to conform to other projects (thereby presenting a timeline 110, or other view, adjusted to accommodate multiple projects).

The search query can seek to match the query using a keyword search to match terms from the query to terms found in the project information. In some configurations, however, the query can trigger a relationship analysis, where words in the query are linked to other words or topics commonly associated with the query. For instance, if the project management system received a query for “shipping,” an analysis could be executed for words related to shipping. While this could produce some synonyms, the analysis could also access Internet databases and determine that the words “container,” “trucks,” “freight,” “crating,” and “carrier” all have a degree of relatedness to “shipping” above a threshold. The analysis can rebuild the relationship graph between words each time a query is made, each time a new query is made (and use pre-existing graphs/relationships when the query has been done before), on a fixed (periodic) timeframe (such as every week, every month, etc.), and/or when specific external triggers are met. Examples of external triggers can include when a new user is added to the system so the project management system can identify patterns and trends associated with the new user's historical data (using emails, white papers, previous work, etc.), or when a new type of product is introduced to the system.

A system can be configured to practice these principles via a method. A server configured as described herein can identifying, in a database, project information associated with a plurality of projects which have not been approved, wherein the project information contains a plurality of fields comprising: a date range for each respective project; a geographic region for each respective project, the geographic region comprising one of a city, a state, a country, a plurality of countries, and a continent; an enabling body responsible for completing each respective project; and a budget approval decision for each respective project. The server can then receive instructions to retrieve the project information and format it for display on a display device, to yield display formatted project information. The server can transmit, to the display device, the display formatted project information for display. The server receives a query for a field in the plurality of fields and modifies the display formatted project information based on the query such that only projects in the plurality of projects associated with the field are displayed, to yield modified display formatted project information. The server then transmits, to the display device, instructions to display the modified display formatted project information.

In some configurations, the query can be received as text, whereas in other configurations the query can be received as audio and converted to text through an automatic speech-to-text conversion. In yet other configurations, the query can be received via a drop-down menu in a graphical user interface.

In some configurations, the method can be further augmented to include performing a similarity analysis of projects stored within the database, wherein the similarity analysis uses online resources to determine a degree of relatedness projects; and generating, based on the similarity analysis, relatedness scores for each project stored within the database to each of remaining projects stored in the database. In such configurations, the modifying of the display formatted project information can be based on the relatedness scores and/or on historical data stored in a database, the historical data being associated with previous queries.

Exemplary Configuration 6: dynamically prioritizing pending projects.

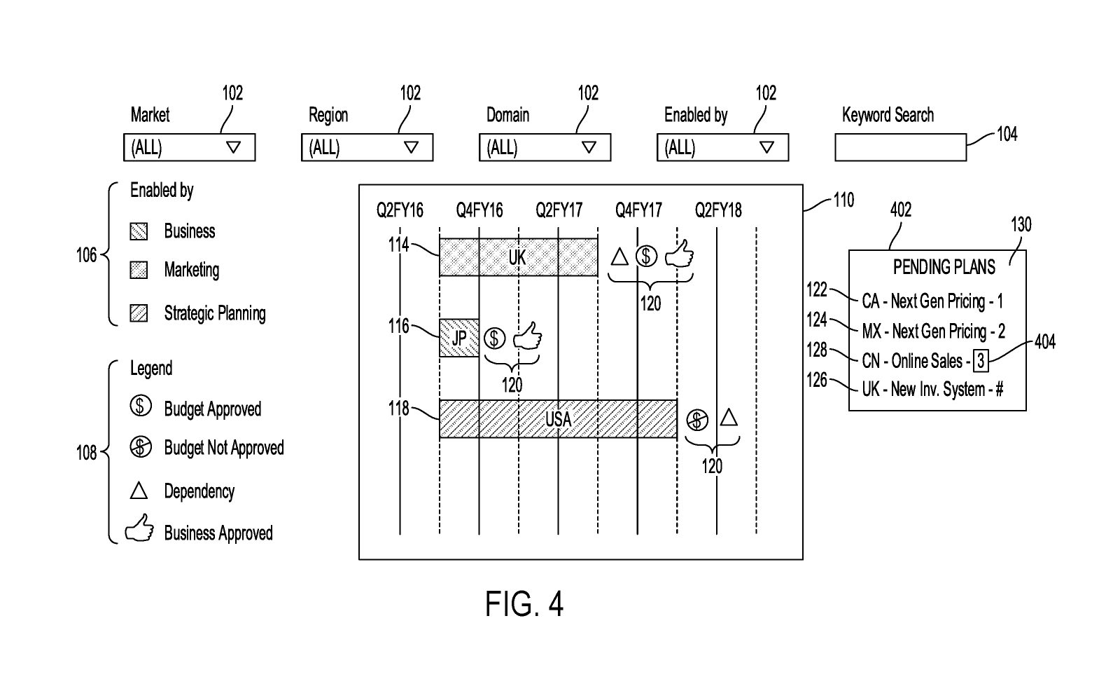

FIG. 4 illustrates the project management system with reprioritized pending plans 402. As illustrated, a previously unprioritized plan 128 from FIG. 1 has been assigned a priority of “3” 404, moving it out of the group of not prioritized plans having a “#” designation. Because the “3” priority of the pending plan 128 falls below both the “1” plan 122 and the “2” plan 124 in priority, the newly prioritized plan 128 is third in the list 130. The remaining pending plan 126 (which is not prioritized) is moved down in the list 130 to await prioritization.

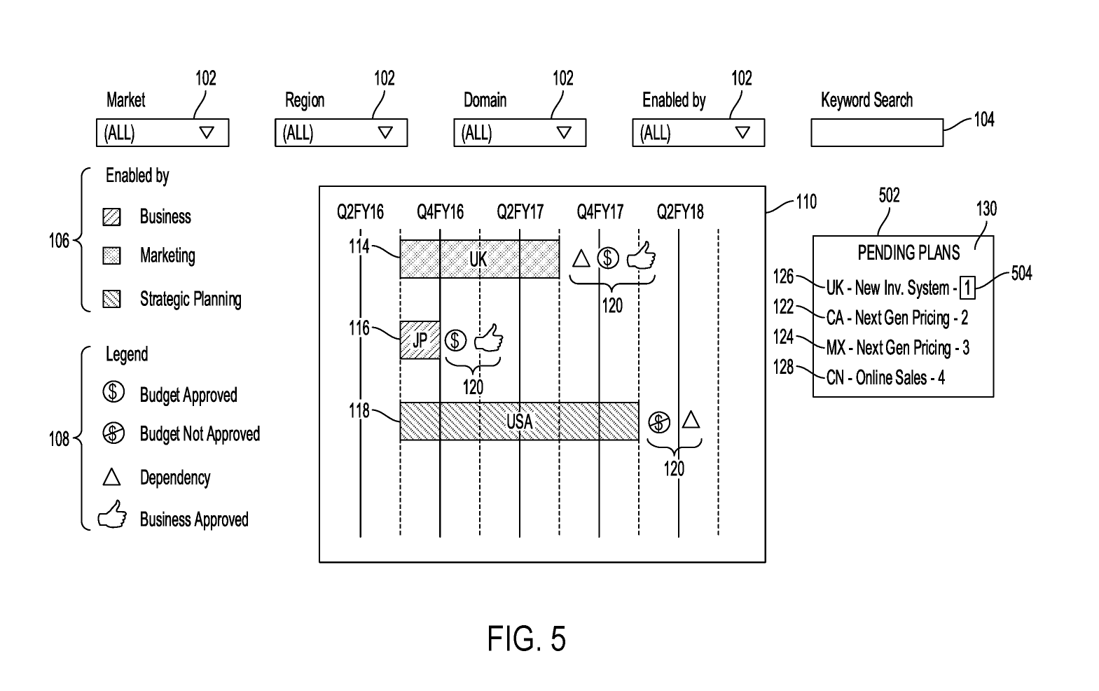

FIG. 5 illustrates the project management system with further reprioritized pending plans 502. In this example, which continues from the example of FIG. 4, the final pending plan 126 is given a priority of “1” 504, causing the list of pending plans 130 to be reorganized. Users can cause the pending projects to rearrange through any manner of control mechanisms. Exemplary ways to instigate the rearrangement can include using a graphical user interface to select and drag pending plans from one location to another. In such an example, the user can use a data entry tool to add or change priority numbers of pending projects.

In other configurations, the priority of the pending projects can be based on other factors, and the system can be configured to make determinations of priority using realtime and historical data. For example, the system can record data regarding which projects are more profitable, which projects are successfully implemented, which projects require more effort to complete, the types of projects which succeed at different points of the year, etc. Using this information, the system can automatically adjust the priorities of the pending plans. This system can apply Artificial Intelligence/Deep Learning algorithms to identify trends in the historical data, apply those trends to real-time data being received, and adjust the priorities based on the outputs of those algorithms.

In some instances, the pending plans can be based on (and readjusted based on) priorities of a larger organization. If, for example, a parent organization issued a new list of priorities for the parent organization, the subsidiary organization could see its priorities automatically readjusted based on the priorities of the parent organization. Identification of which pending plans will be affected by shifts of that parent organization's priorities can be based on coding of the pending plans within a database, or can be determined based on contextual information found in individual project plan information.

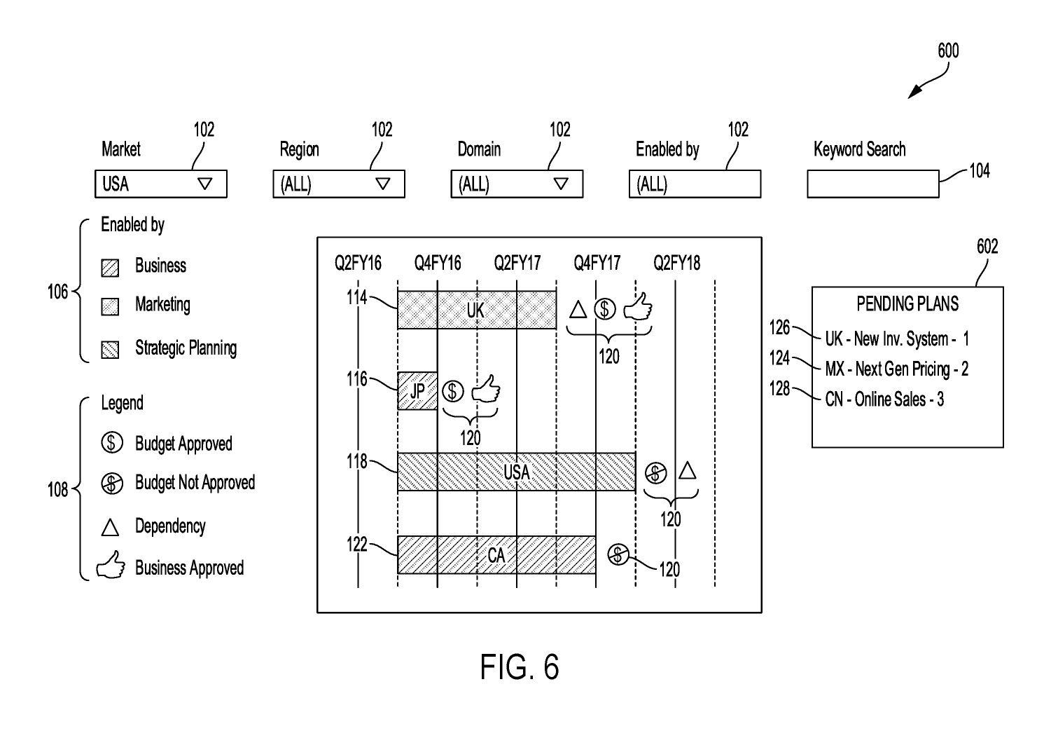

FIG. 6 illustrates the project management system when a pending project is no longer pending. In FIG. 6, which continues the example provided in FIG. 4, the pending plans 602 are adjusted to only contain three pending plans 124, 126, 128. Plan 122 has been approved, removed from the pending plans 602, and inserted into the timeline display area. Symbols associated with project 122 are likewise displayed. The remaining pending plans 124, 126, 128 are again re-prioritized, into a new order.

A system can be configured to practice these principles via a method. The server identifies, in a database, project information associated with a plurality of projects which have not been approved, wherein the project information comprises: a project domain; a date range for each respective project; a geographic region for each respective project, the geographic region comprising one of a city, a state, a country, a plurality of countries, and a continent; an enabling body responsible for completing each respective project; and a budget approval decision for each respective project;

The server can also establish a first priority for each project in the plurality of projects, wherein the first priority is established by: identifying, a world-wide marketing strategy; identifying a region-specific marketing strategy for the geographic region; identifying, within the geographic region, domain priorities specific to the geographic region; retrieving priority rules, the priority rules providing relationships between the world-wide marketing strategy, the region-specific marketing strategy, the domain priorities specific to the geographic region, and sales of products within the project domain in the geographic region; and generating, via a processor, a priority score, the priority score being the result of a weighted formula, wherein for the weighted formula each item within the project information is weighted according to the priority rules.

At this point the server can transmit, to a display device, instructions to display a priority for a project in the plurality of projects based on the priority score for the project. The server can receive updated sales of products within the project domain in the geographic region and modify, via the processor, the priority rules based on the updated sales of products, to yield modified priority rules.

The server can then generate, via the processor, an updated priority score using the modified priority rules and transmit, to the display device, instructions to display an updated priority for the project based on the updated priority score for the project.

In some configurations, the updated sales of products received by the server are occurring in real-time. For example, as a product is purchased within a store within the geographic region, the server can receive an update indicating the sale, then trigger the modifying of the priority rules based on that sale. In other configurations, the updated sales of products can be received by the server in real-time, those updated sales stored, then the priority rules can be modified on a periodic basis—such as updating the priority rules on a daily, weekly, monthly, or quarterly basis.

Modifying of the priority rules can require modifying a source code which, when executed by a processor on the server, results in the weighted formula. For example, the portion of the computer memory which contains the source code which, when executed, results in the processor producing the weighted formula, can be modified such that in future executions, how the processor forms the weighted formula is distinct.

In some configurations, the database can be a Structured Query Language (SQL) database.

In some configurations, the weighted formula can have, as another factor in calculating the priority score, a length of time a project has been pending. Other possible factors within the weighted formula can include wholesale costs of the products, average time spent in inventory prior to sale,

In some configurations, the updated priority causes a shift in where the project sits within a list of the plurality of projects.

Exemplary Configuration 7: reprioritizing pending plans. As illustrated in FIG. 4, a previously unprioritized plan 128 from FIG. 1 has been assigned a priority of “3” 404, moving it out of the group of not prioritized plans having a “#” designation. Because the “3” priority of the pending plan 128 falls below both the “1” plan 122 and the “2” plan 124 in priority, the newly prioritized plan 128 is third in the list 130. The remaining pending plan 126 (which is not prioritized) is moved down in the list 130 to await prioritization.

FIG. 5 illustrates the project management system with further reprioritized pending plans 502. In this example, which continues from the example of FIG. 4, the final pending plan 126 is given a priority of “1” 504, causing the list of pending plans 130 to be reorganized. Users can cause the pending projects to rearrange through any manner of control mechanisms. Exemplary ways to instigate the rearrangement can include using a graphical user interface to select and drag pending plans from one location to another. In such an example, the user can use a data entry tool to add or change priority numbers of pending projects.

In other configurations, the priority of the pending projects can be based on other factors, and the system can be configured to make determinations of priority using realtime and historical data. For example, the system can record data regarding which projects are more profitable, which projects are successfully implemented, which projects require more effort to complete, the types of projects which succeed at different points of the year, etc. Using this information, the system can automatically adjust the priorities of the pending plans. This system can apply Artificial Intelligence/Deep Learning algorithms to identify trends in the historical data, apply those trends to real-time data being received, and adjust the priorities based on the outputs of those algorithms.

In some instances, the pending plans can be based on (and readjusted based on) priorities of a larger organization. If, for example, a parent organization issued a new list of priorities for the parent organization, the subsidiary organization could see its priorities automatically readjusted based on the priorities of the parent organization. Identification of which pending plans will be affected by shifts of that parent organization's priorities can be based on coding of the pending plans within a database, or can be determined based on contextual information found in individual project plan information.

FIG. 6 illustrates the project management system when a pending project is no longer pending. In FIG. 6, which continues the example provided in FIG. 4, the pending plans 602 are adjusted to only contain three pending plans 124, 126, 128. Plan 122 has been approved, removed from the pending plans 602, and inserted into the timeline display area. Symbols associated with project 122 are likewise displayed. The remaining pending plans 124, 126, 128 are again re-prioritized, into a new order.

A system can be configured to practice these principles via a method. This method can, for example, be performed by a server or other computing device connected to databases and display devices. The server identifies, in a database, project information associated with a plurality of projects which have not been approved, wherein the project information comprises: a date range for each respective project; a geographic region for each respective project, the geographic region comprising one of a city, a state, a country, a plurality of countries, and a continent; an enabling body responsible for completing each respective project; and a budget approval decision for each respective project. The server receives instructions to retrieve the project information and format it for display on a display device, to yield display formatted project information, and transmits, to the display device, the display formatted project information for display, wherein, the plurality of projects have not been assigned relative priorities and are displayed in a first order.

Once the projects and priorities are displayed in the first order, the server receives, receiving, for a first project in the plurality of projects, a first priority, and modifies the first order based on the first priority, to create a second order. The server then transmits, to the display device, instructions to display the plurality of projects in the second order.

Once the projects and priorities are displayed in the second order, the server receives, for a second project in the plurality of projects, a second priority which is higher than the first priority and modifies the second order based on the first priority and the second priority, to create a third order. The server transmits, to the display device, instructions to display the plurality of projects in the third order.

In some configurations the described method can be expanded to include receiving an approval of an approved project in the plurality of projects; modifying the third order based on the first priority, the second priority, and the approval, to create a fourth order; and displaying the plurality of projects, without the approved project, in the fourth order. Another way in which the method may be expanded can include receiving a rejection of a rejected project in the plurality of projects; modifying the third order based on the first priority, the second priority, and the rejection, to create a fourth order; and displaying the plurality of projects, without the rejected project, in the fourth order.

In certain configurations, the first order can be organized based on a geographic area of each project in the plurality of projects. In such configurations, the method can, for example, include receiving a selection of a geographic area; and removing projects not associated with the geographic area from the plurality of projects. In yet other configurations, the first order may be organized based on an organization assigned to complete each project in the plurality of projects. In yet other configurations, projects which have not been assigned relative priorities can have a placeholder priority, where the placeholder priority is illustrated by the display device.

Exemplary configuration 8: scaling displayed project management information.

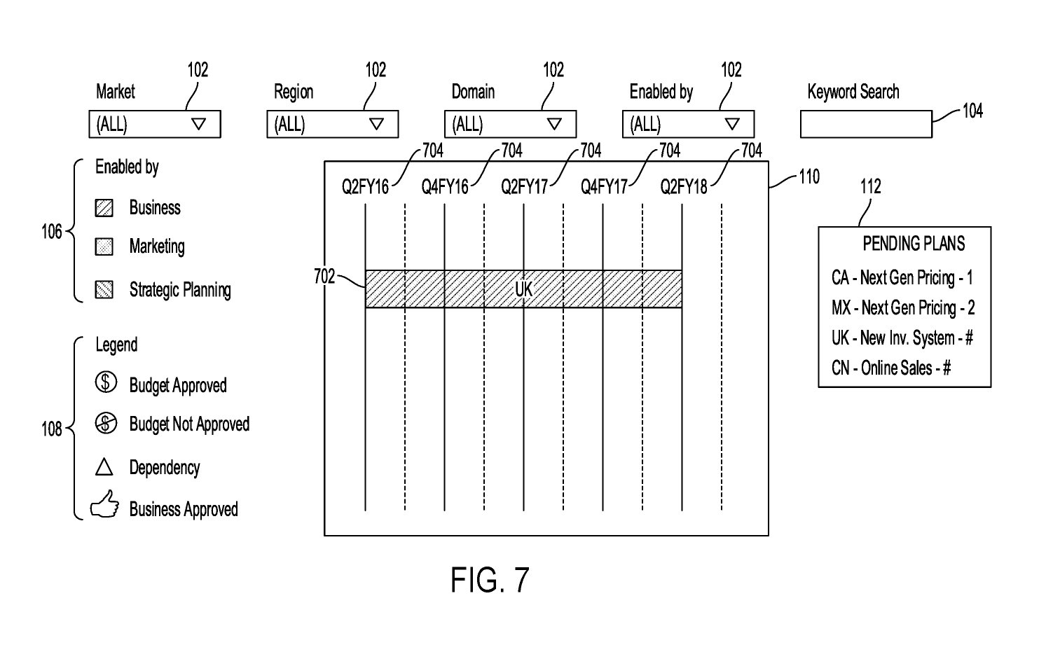

FIG. 7 illustrates an exemplary view of the project management system when a first project 702 is selected for display. The first project 702 is illustrated as a horizontal bar extending across the time periods 114 of the timeline display area 110. In this illustration, the time periods 114 of FIG. 1 match the time periods of FIG. 7. However, in other instances a project selected may not match the default time periods 114 illustrated in FIG. 1, such that the project management system either (1) scales the time periods 114 so that the selected project can appear within the timeline display area and/or (2) formats the project information such that it is displayed within a fixed timeline display area. In other words, either the timeline display area is scaled, or the project information is scaled, such that the project information is properly displayed.

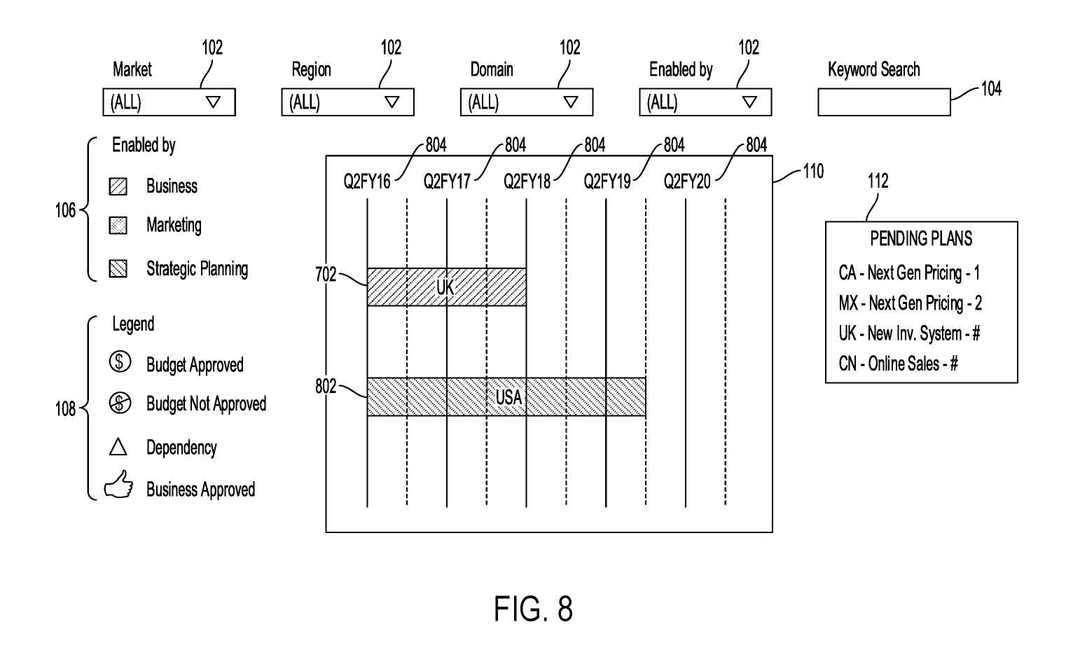

FIG. 8 illustrates an exemplary view of the project management system when the display area is scaled for the first project 702 and a second project 802. In this example, the second project 802 has a longer duration than the first project 702, and the project management system responded by (1) adjusting the time scale of the timeline display area 110 such that the time periods 304 now represent more time than in FIG. 7, and (2) formatting the project information of the first project 702 such that the first project 702 is displayed in a manner where the horizontal bar extends across the same amount of time, but because the time periods 04 have shifted the size of the horizontal bar on the display device is smaller.

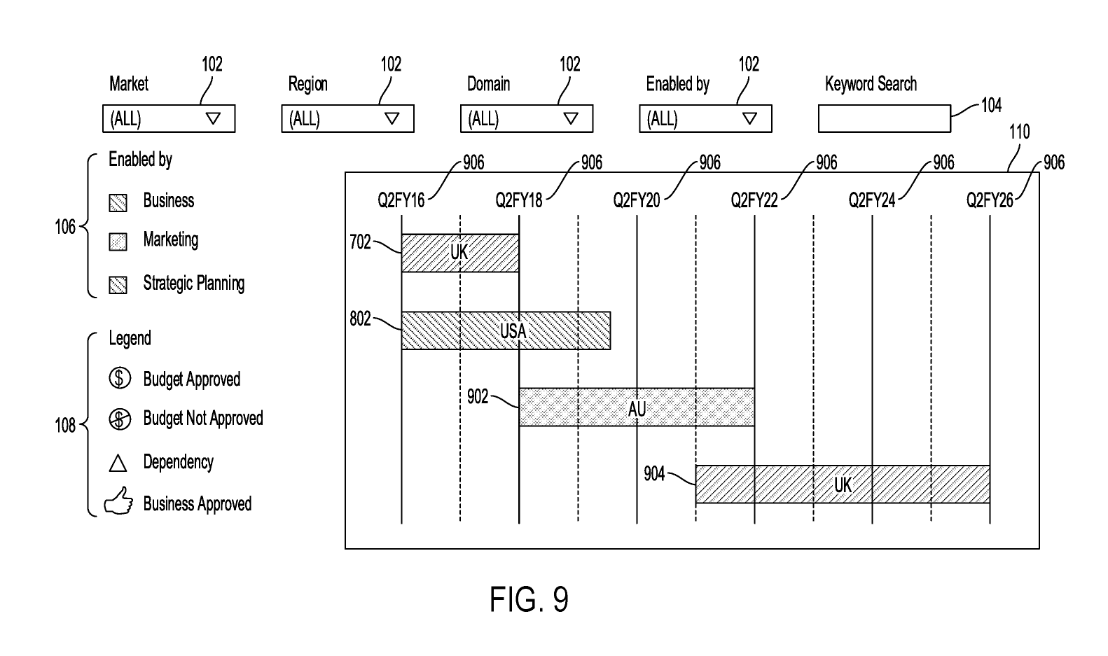

FIG. 9 illustrates an exemplary view of the project management system when adjusted for additional projects 902, 904. In this example, projects 902, 904 have been added to the timeline display area 110, which again causes a shift in the time periods 906. The addition of the projects 902, 904 to the timeline display area 110 also causes the system to reformat project information associated with projects 702 and 802, such that the projects correctly display within the display area.

The project management system in this example has also determined that the projects 702, 802, 902, 904 selected could not be correctly displayed with all of the standard sections of the project display. In this case, the project management system has determined that the Pending Projects section 112, illustrated to the right of the timeline display area 110 in FIGS. 7-9, should be removed to make additional room for the timeline display area 110. This determination can be made by the project management system based on factors such as the number of pending plans being below a threshold number, a frequency of modifying the pending plans being above or below a threshold, activity when specific projects, or combinations or projects, are being presented, and historical data.

Likewise, the project management system can determine if other sections of the project management system being displayed (such as the enabling organization section 106, the menus 102, 104, or the legend 108) should be removed based on usage, historical trends, space requirements, user preferences, and/or machine learning, artificial intelligence, deep learning mechanisms. In some configurations, historical data regarding how the user interacts with the project management display can be recorded in a database, and the project management system can employ deep learning to identify trends within that user behavior. In other configurations, rather than remove a section 102, 104, 106, 108, 112 of the project management system being displayed, the system can resize or otherwise manipulate the sections to provide space for the projects to be accurately displayed. The modifications to the timeline display area 110; the modifications to the project information for individual projects 702, 802, 902, 904; and the resizing, removing, removal, or relocating of sections 102, 104, 106, 108, 112 from the project management system display, can all be performed using by the project management system as the project management system employs machine learning. The machine learning can seek to improve the speed at which changes are made once an input is received, seek to mimic changes which a user would normally make, and can seek to reduce the number of additional modifications user make to the displayed project information.

For example, the project management system can record changes a user makes to the display area to accommodate project information. Exemplary data which can be recorded can include the types of projects, the organizations tasked with completing the projects, the timelines associated with the projects, etc. In addition, record can be kept of how the user manipulates the various sections 102, 104, 106, 108, 110, 112 being displayed. In future instances where the data being displayed reaches a threshold similarity to the previous instance, the system can automatically make those adjustments again. In some configurations, this can be done on a user basis (such as based on previous changes that a particular user often makes, or based on the user's preferences), while in some configurations the modifications can be done regardless of who has previously made changes or who is currently using the system.

A system can be configured to practice these principles via a method. A server configured as described herein can identify, in a database, project information associated with a first project and a second project, wherein the project information comprises: a date range for each respective project; a geographic region for each respective project, the geographic region comprising one of a city, a state, a country, a plurality of countries, and a continent; an enabling body responsible for completing each respective project; and a budget approval decision for each respective project. The server can then receive, a first request to display first project information associated with the first project and retrieves, from the database, the first project information. The server then receives a second request to display, simultaneously with the first project information, second project information associated with a second project. The server identifies a current date, and determines, based on the current date, the date range of the first project, and the date range of the second project, a scaled display area scaled for the first project information and the second project information. The server then formats the first project information and the second project information to fit within the scaled display area, to yield display formatted project information and transmits, to a display device, the scaled display area and the display formatted project information for display.

In some configurations the display formatted project information, when displayed, is a horizontal bar representing each respective project extending across a time domain, where a length of the horizontal bar represents the date range for each respective project. Next to each horizontal bar can be symbols associated with other portions of the project information for each respective project.

In one configuration, the method can be augmented by determining, based on the project information for each respective project, a project dependency tree, and the server can then transmit, to the display device, instructions to display a dependency symbol indicating dependency for each project depending on another project.

In another configuration, the method can be augmented by receiving instructions to add a third project to the display formatted project information, and determining, based on the current date, the date range of the first project, and the date range of the second project, a modified scaled display area scaled for the first project information, second project information, and third project information associated with the third project. The server can then format the first project information, the second project information, and the third project information to fit within the scaled display area, to yield expanded display formatted project information. At that point, the server can transmit, to the display device, the modified scaled display area and the expanded display formatted project information for display.

In yet another configuration, the server can modify the display formatted project information within the scaled display area to allow for displaying, next to the scaled display area, columns associated with a domain for each project, a group assigned to perform each project, and a market strategy for each project. In such configurations, the display formatted project information can be reorganized by clicking on any field for the domain, the group assigned, and the market strategy within the columns.

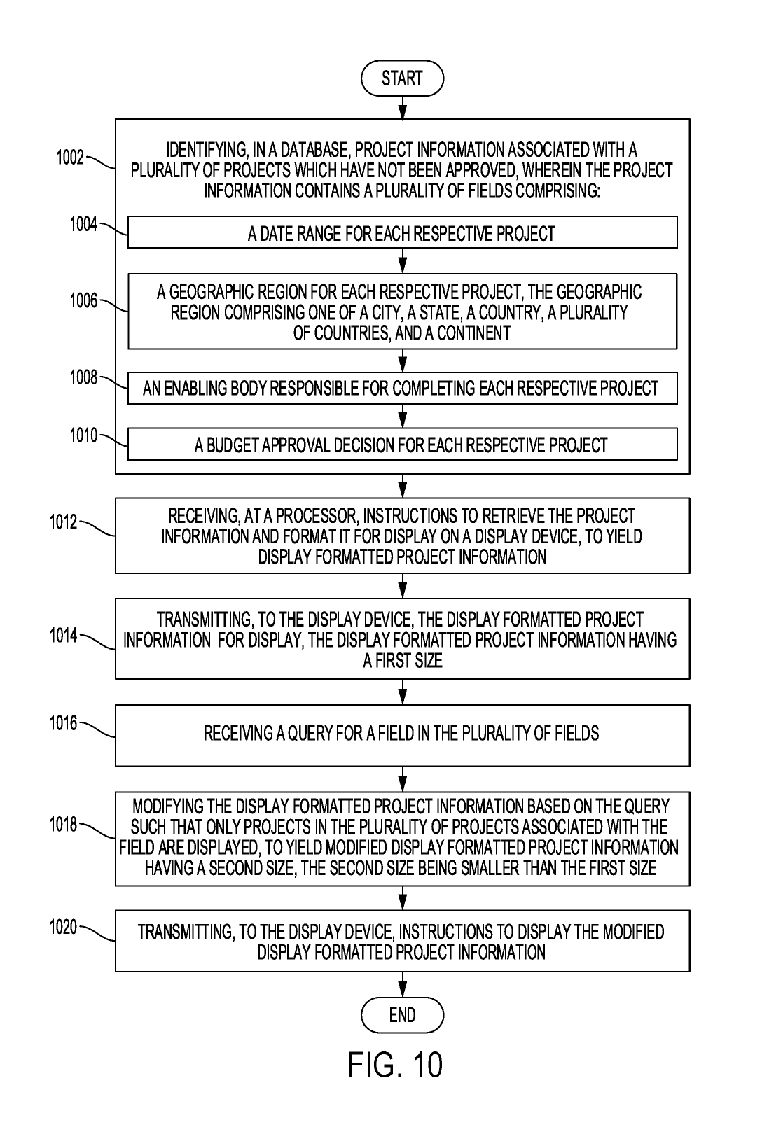

Exemplary configuration 9: As illustrated in FIG. 10, another exemplary method which can be performed according to the concepts disclosed herein can include: identifying, in a database, project information associated with a plurality of projects which have not been approved, wherein the project information contains a plurality of fields (1002) comprising: a date range for each respective project (1004); a geographic region for each respective project, the geographic region comprising one of a city, a state, a country, a plurality of countries, and a continent (1006); an enabling body responsible for completing each respective project (1008); and a budget approval decision for each respective project (1010). The system receives, at a processor, instructions to retrieve the project information and format it for display on a display device, to yield display formatted project information (1012). The system also transmits, to the display device, the display formatted project information for display, the display formatted project information having a first size (1014).

The system receives a query for a field in the plurality of fields (1016) and modifies the display formatted project information based on the query such that only projects in the plurality of projects associated with the field are displayed, to yield modified display formatted project information having a second size, the second size being smaller than the first size (1018). The system transmits, to the display device, instructions to display the modified display formatted project information (1020).

In some configurations, the query can be received as text, whereas in others they can be received as speech and converted to text (via a processor specifically configured to perform speech to text).

In some configurations, the method described can be modified to include performing a similarity analysis of projects stored within the database, wherein the similarity analysis uses online resources to determine a degree of relatedness projects; and generating, based on the similarity analysis, relatedness scores for each project stored within the database to each of remaining projects stored in the database. In such configurations, the modifying of the display formatted project information is further based on the relatedness scores.

In some configurations, the query can be received via a drop-down menu in a graphical user interface.

In some configurations, the modifying of the display formatted project information can be based on historical data which is stored in the database, the historical data being associated with previous queries.

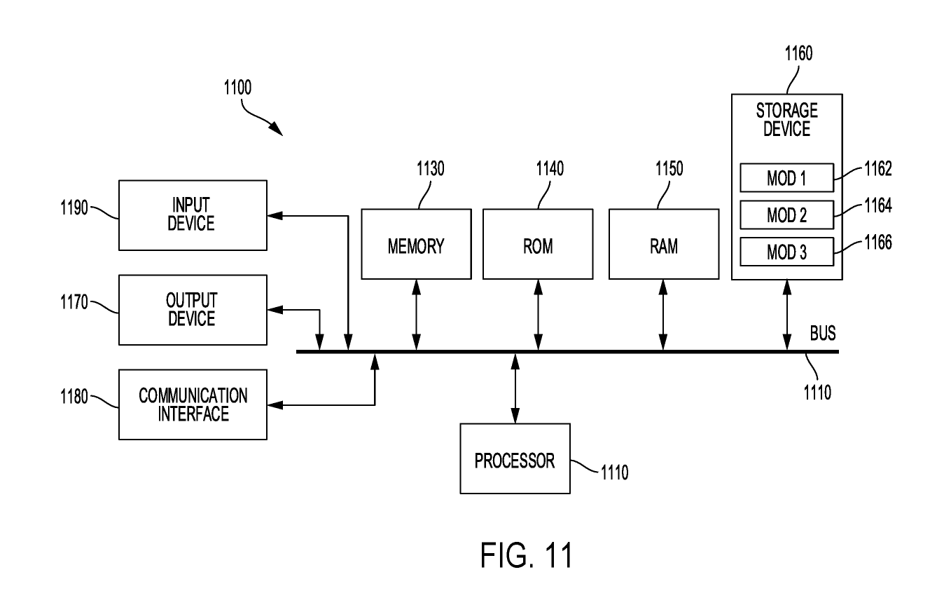

FIG. 11 illustrates an exemplary general-purpose computing device 1100, including a processing unit (CPU or processor) 1120 and a system bus 1110 that couples various system components including the system memory 1130 such as read only memory (ROM) 1140 and random access memory (RAM) 1150 to the processor 1120. The system 1100 can include a cache 1122 of high speed memory connected directly with, in close proximity to, or integrated as part of the processor 1120. The system 1100 copies data from the memory 1130 and/or the storage device 1160 to the cache 1122 for quick access by the processor 1120. In this way, the cache provides a performance boost that avoids processor 1120 delays while waiting for data. These and other modules can control or be configured to control the processor 1120 to perform various actions. Other system memory 1130 may be available for use as well. The memory 1130 can include multiple different types of memory with different performance characteristics. It can be appreciated that the disclosure may operate on a computing device 1100 with more than one processor 1120 or on a group or cluster of computing devices networked together to provide greater processing capability. The processor 1120 can include any general purpose processor and a hardware module or software module, such as module 1 1162, module 2 1164, and module 3 1166 stored in storage device 1160, configured to control the processor 1120 as well as a special-purpose processor where software instructions are incorporated into the actual processor design. The processor 1120 may essentially be a completely self-contained computing system, containing multiple cores or processors, a bus, memory controller, cache, etc. A multi-core processor may be symmetric or asymmetric.

The system bus 1110 may be any of several types of bus structures including a memory bus or memory controller, a peripheral bus, and a local bus using any of a variety of bus architectures. A basic input/output (BIOS) stored in ROM 1140 or the like, may provide the basic routine that helps to transfer information between elements within the computing device 1100, such as during start-up. The computing device 1100 further includes storage devices 1160 such as a hard disk drive, a magnetic disk drive, an optical disk drive, tape drive or the like. The storage device 1160 can include software modules 1162, 1164, 1166 for controlling the processor 1120. Other hardware or software modules are contemplated. The storage device 1160 is connected to the system bus 1110 by a drive interface. The drives and the associated computer-readable storage media provide nonvolatile storage of computer-readable instructions, data structures, program modules and other data for the computing device 1100. In one aspect, a hardware module that performs a particular function includes the software component stored in a tangible computer-readable storage medium in connection with the necessary hardware components, such as the processor 1120, bus 1110, display 1170, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 1100 is a small, handheld computing device, a desktop computer, or a computer server.

Although the exemplary embodiment described herein employs the hard disk 560, other types of computer-readable media which can store data that are accessible by a computer, such as magnetic cassettes, flash memory cards, digital versatile disks, cartridges, random access memories (RAMs) 1150, and read only memory (ROM) 1140, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 1100, an input device 1190 represents any number of input mechanisms, such as a microphone for speech, a touch-sensitive screen for gesture or graphical input, keyboard, mouse, motion input, speech and so forth. An output device 1170 can also be one or more of a number of output mechanisms known to those of skill in the art. In some instances, multimodal systems enable a user to provide multiple types of input to communicate with the computing device 1100. The communications interface 1180 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
identifying, in a database, project information associated with a plurality of projects which have not been approved, wherein the project information contains a plurality of fields comprising:
a date range for each respective project;
a geographic region for each respective project, the geographic region comprising one of a city, a state, a country, a plurality of countries, and a continent;
an enabling body responsible for completing each respective project; and
a budget approval decision for each respective project;
receiving, at a processor, instructions to retrieve the project information and format it for display on a display device, to yield display formatted project information;
transmitting, to the display device, the display formatted project information for display, the display formatted project information having a first size;
receiving a query for a field in the plurality of fields;
modifying the display formatted project information based on the query such that only projects in the plurality of projects associated with the field are displayed, to yield modified display formatted project information having a second size, the second size being smaller than the first size; and
transmitting, to the display device, instructions to display the modified display formatted project information.

2. The method of claim 1, wherein the query is received, at the processor, as text.

3. The method of claim 1, wherein the processor is configured to perform speech-to-text processing, and
wherein the query is received, at the processor, as audio and converted to text, via the processor, through an automatic speech-to-text conversion.

4. The method of claim 1, further comprising:
performing a similarity analysis of projects stored within the database, wherein the similarity analysis uses online resources to determine a degree of relatedness projects; and
generating, based on the similarity analysis, relatedness scores for each project stored within the database to each of remaining projects stored in the database.

5. The method of claim 4, wherein the modifying of the display formatted project information is further based on the relatedness scores.

6. The method of claim 1, wherein the query is received via a drop-down menu in a graphical user interface.

7. The method of claim 1, wherein the modifying of the display formatted project information is further based on historical data, stored in the database, the historical data being associated with previous queries.

8. A system comprising:
a database;
a display device;
a processor; and
a computer-readable storage medium having instructions stored which, when executed by the processor, cause the processor to perform operations comprising:
identifying, in the database, project information associated with a plurality of projects, wherein the project information contains a plurality of fields comprising:
a date range for each respective project;
a geographic region for each respective project, the geographic region comprising one of a city, a state, a country, a plurality of countries, and a continent;
an enabling body responsible for completing each respective project;
a market strategy for each respective project;
a domain for each respective project; and
a budget approval decision for each respective project;
receiving instructions to retrieve the project information and format it for display on a display device, to yield display formatted project information;
transmitting, to the display device, the display formatted project information for display;
receiving a query for a field in the plurality of fields;
modifying the display formatted project information based on the query such that only projects in the plurality of projects associated with the field are displayed, to yield modified display formatted project information; and
transmitting, to the display device, instructions to display the modified display formatted project information.

9. The system of claim 8, wherein the query is received as text.

10. The system of claim 8, wherein the query is received as audio and converted to text through an automatic speech-to-text conversion.

11. The system of claim 8, the computer-readable storage medium having additional instructions stored which, when executed by the processor, cause the processor to perform operations comprising:
performing a similarity analysis of projects stored within the database, wherein the similarity analysis uses online resources to determine a degree of relatedness projects; and
generating, based on the similarity analysis, relatedness scores for each project stored within the database to each of remaining projects stored in the database.

12. The system of claim 11, wherein the modifying of the display formatted project information is further based on the relatedness scores.

13. The system of claim 8, wherein the query is received via a drop-down menu in a graphical user interface.

14. The system of claim 8, wherein the modifying of the display formatted project information is further based on historical data, stored in the database, the historical data being associated with previous queries.

15. A non-transitory computer-readable storage medium having instructions stored which, when executed by a computing device, cause the computing device to perform operations comprising:
identifying, in a database, project information associated with a plurality of projects, wherein the project information contains a plurality of fields comprising:
a date range for each respective project;
a geographic region for each respective project, the geographic region comprising one of a city, a state, a country, a plurality of countries, and a continent;
an enabling body responsible for completing each respective project; and
a budget approval decision for each respective project;
receiving instructions to retrieve the project information and format it for display on a display device, to yield display formatted project information;
transmitting, to the display device, the display formatted project information for display;
receiving a query for a field in the plurality of fields;
modifying the display formatted project information based on the query such that only projects in the plurality of projects associated with the field are displayed, to yield modified display formatted project information; and
transmitting, to the display device, instructions to display the modified display formatted project information.

16. The non-transitory computer-readable storage medium of claim 15, wherein the query is received as text.

17. The non-transitory computer-readable storage medium of claim 15, wherein the query is received as audio and converted to text through an automatic speech-to-text conversion.

18. The non-transitory computer-readable storage medium of claim 15, having additional instructions stored which, when executed by the computing device, cause the computing device to perform operations comprising:
performing a similarity analysis of projects stored within the database, wherein the similarity analysis uses online resources to determine a degree of relatedness projects; and
generating, based on the similarity analysis, relatedness scores for each project stored within the database to each of remaining projects stored in the database.

19. The non-transitory computer-readable storage medium of claim 18, wherein the modifying of the display formatted project information is further based on the relatedness scores.

20. The non-transitory computer-readable storage medium of claim 15, wherein the query is received via a drop-down menu in a graphical user interface.
